(19) United States
(12) Patent Application Publication
(10) Pub. No.: US 2022/0341775 A1
(43) Pub. Date: Oct. 27, 2022

(54) ANOMALY DETECTION APPARATUS, ANOMALY DETECTION METHOD, AND NON-TRANSITORY COMPUTER READABLE MEDIUM

(71) Applicant: NEC Corporation, Tokyo (JP)

(72) Inventors: Yasuyuki FUKUTA, Tokyo (JP); Yasuharu Onishi, Tokyo (JP); Koji Sano, Tokyo (JP); Michio Shibata, Tokyo (JP); Sae Watanabe, Tokyo (JP)

(73) Assignee: NEC Corporation, Tokyo (JP)

(21) Appl. No.: 17/718,555

(22) Filed: Apr. 12, 2022

(30) Foreign Application Priority Data
Apr. 21, 2021 (JP) 2021-071603

(51) Int. Cl. G01H 17/00; B65G 43/02

(52) U.S. Cl. CPC G01H 17/00; B65G 43/02

(57) ABSTRACT

To determine, with high accuracy, whether an anomaly has occurred in equipment to be monitored, an anomaly detection apparatus includes an acquisition unit and a determination unit. The determination unit acquires detection result information indicating a detection result of a vibration sensor attached to equipment including a movable unit. The determination unit determines, by using the detection result information, presence or absence of an anomaly of the equipment. The detection result information includes a magnitude of a vibration of each of a plurality of axes oriented in directions different from each other. The determination unit computes, with respect to each of the plurality of axes, a difference between a magnitude of a vibration at a target timing, and a magnitude of a vibration at a predetermined period of time before the target timing or a criterion value previously set. Then, the determination unit determines, when the difference exceeds a criterion in any of the axes, that an anomaly is occurring in the equipment at the target timing.

This application is based on Japanese patent application No. 2021-071603, the content of which is incorporated hereinto by reference.

### BACKGROUND

### Technical Field

The present invention relates to an anomaly detection apparatus, an anomaly detection method, and a program.

### Related Art

In order to monitor equipment, a method using a vibration sensor is available. Patent Document 1 (International Publication No. WO2019/168086), for example, describes that a rolling bearing is attached with three vibration sensors, detection results of the vibration sensors are processed by using a learning model, and thereby a defect of the rolling bearing is detected. In Patent Document 1, the three sensors detect vibrations in directions different from one another.

### SUMMARY

The present inventor has studied a new technique that determines, with high accuracy, whether an anomaly has occurred in a monitoring target. One example of an object of the present invention is to determine, with high accuracy, whether an anomaly has occurred in a monitoring target.

In one example embodiment, there is provided an anomaly detection apparatus including:

an acquisition unit that acquires detection result information indicating a detection result of a vibration sensor attached to equipment including a movable unit; and

a determination unit that determines, by using the detection result information, presence or absence of an anomaly of the equipment, in which

the detection result information includes a magnitude of a vibration of each of a plurality of axes oriented in directions different from each other, and

the determination unit
computes, with respect to each of the plurality of axes, a difference between a magnitude of a vibration at a target timing and a magnitude of a vibration at a predetermined period of time before the target timing or a criterion value previously set, and
determines, when the difference exceeds a criterion in any of the axes, that an anomaly is occurring in the equipment at the target timing.

In another example embodiment, there is provided an anomaly detection method including:

by a computer, executing
acquisition processing of acquiring detection result information indicating a detection result of a vibration sensor attached to equipment including a movable unit; and
determination processing of determining, by using the detection result information, presence or absence of an anomaly of the equipment, in which

the detection result information includes a magnitude of a vibration of each of a plurality of axes oriented in directions different from each other, and

the computer, in the determination processing,
computes, with respect to each of the plurality of axes, a difference between a magnitude of a vibration at a target timing and a magnitude of a vibration at a predetermined period of time before the target timing or a criterion value previously set, and
determines, when the difference exceeds a criterion in any of the axes, that an anomaly is occurring in the equipment at the target timing.

In still another example embodiment, there is provided a program causing a computer to include:
an acquisition function of acquiring detection result information indicating a detection result of a vibration sensor attached to equipment including a movable unit; and
a determination function of determining, by using the detection result information, presence or absence of an anomaly of the equipment, in which

the detection result information includes a magnitude of a vibration of each of a plurality of axes oriented in directions different from each other, and

the determination function
computes, with respect to each of the plurality of axes, a difference between a magnitude of a vibration at a target timing and a magnitude of a vibration at a predetermined period of time before the target timing or a criterion value previously set, and
determines, when the difference exceeds a criterion in any of the axes, that an anomaly is occurring in the equipment at the target timing.

According to the present invention, it can be determined, with high accuracy, whether an anomaly has occurred in equipment to be monitored.

### BRIEF DESCRIPTION OF THE DRAWINGS

The above and other objects, advantages and features of the present invention will be more apparent from the following description of certain preferred example embodiments taken in conjunction with the accompanying drawings, in which:

FIG. 1 is a diagram for illustrating a usage environment of an anomaly detection apparatus according to an example embodiment;

FIG. 2 is a diagram for illustrating data detected by a vibration sensor;

FIG. 3 is a diagram illustrating one example of a function configuration of the anomaly detection apparatus;

FIG. 4 is a diagram illustrating a hardware configuration example of the anomaly detection apparatus; and

FIG. 5 is a flowchart illustrating one example of processing executed by the anomaly detection apparatus.

### DETAILED DESCRIPTION

The invention will be now described herein with reference to illustrative example embodiments. Those skilled in the art will recognize that many alternative example embodiments can be accomplished using the teachings of the present invention and that the invention is not limited to the example embodiments illustrated for explanatory purposes.

Hereinafter, an example embodiment according to the present invention is described by using the accompanying drawings. Note that, in all drawings, a similar component is assigned with a similar reference sign, and description thereof is not repeated as appropriate.

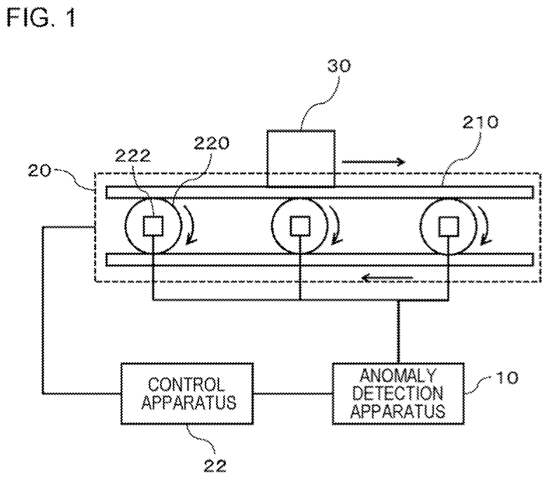

FIG. 1 is a diagram for illustrating a usage environment of an anomaly detection apparatus 10 according to the example embodiment. The anomaly detection apparatus 10 according to the example embodiment processes a vibration generated in equipment 20 to be monitored, and thereby detects and/or predicts an anomaly of the equipment 20. The equipment 20 is provided, for example, in a factory. In the following description, it is assumed that the equipment 20 is a belt conveyer. The belt conveyer conveys coal, coke, and the like, for example, in an ironworks and an electric power plant. Further, when the belt conveyer is installed in an ironworks, the belt conveyer may convey an iron ore.

The equipment 20 is attached with at least one vibration sensor 222. In an example illustrated in the present figure, the equipment 20 includes a plurality of rotary shafts 220. The vibration sensor 222 detects a vibration generated in a belt 210 or the rotary shaft 220 of the equipment 20. In the example illustrated in the present figure, the vibration sensor 222 is attached to each of a plurality of rotary shafts 220 or a vicinity of each of the plurality of rotary shafts 220. However, the vibration sensor 222 may also be attached to another portion of the equipment 20. As detailed are described later, the vibration sensor 222 detects a vibration of each of a plurality of axes (e.g., three axes) different from one another.

As an anomaly occurring in the equipment 20, there are a partial fracture of the belt 210, a fall of a conveyed object 30, an anomaly of the rotary shaft 220, displacement of alignment, and the like. Then, when the anomaly occurs or when the anomaly is about to occur, a vibration different from normal is generated in the belt 210 or the rotary shaft 220. The anomaly detection apparatus 10 processes a vibration detected by the vibration sensor 222, and thereby detects the anomaly or predicts occurrence of an anomaly.

The equipment 20 is controlled by a control apparatus 22. The anomaly detection apparatus 10 acquires, from the control apparatus 22, control information of the equipment 20, and detects and/or predicts an anomaly by using the control information.

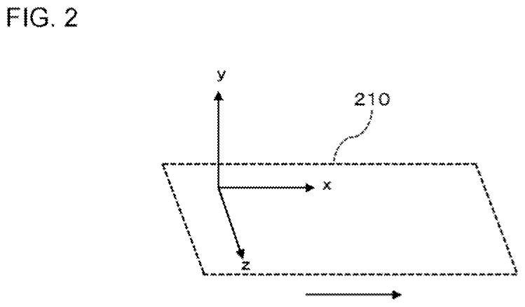

FIG. 2 is a diagram for illustrating data detected by the vibration sensor 222. As described above, the vibration sensor 222 detects a vibration of each of a plurality of axes, e.g., three axes, different from one another. In an example illustrated in the present figure, it is assumed that a direction parallel to a moving direction of the belt 210 is an x axis (first axis), a direction vertical to a surface of the belt 210 is a y axis, (second axis), and a direction parallel to a width direction of the belt 210 is a z axis (third axis). The vibration sensor 222 detects a vibration of each of these three axes.

Note that, the vibration sensor 222 may include three sensors, or may be one sensor. Further, the vibration sensor 222 may detect a vibration of each of two axes (e.g., an x axis and a y axis, an x axis and a z axis, or a y axis and a z axis). Further, the vibration sensor 222 may detect a vibration of each of directions of equal to or more than four axes. In this case, an angle formed by at least two of four axes is less than 90°.

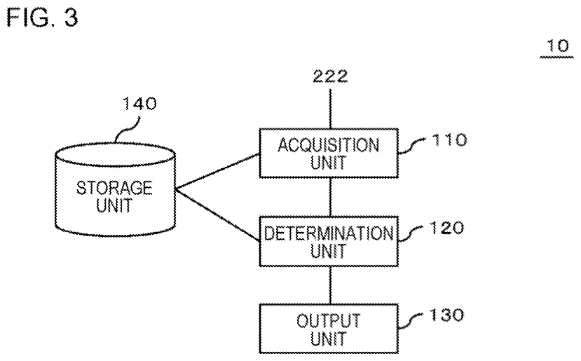

FIG. 3 is a diagram illustrating one example of a function configuration of the anomaly detection apparatus 10. The anomaly detection apparatus 10 includes an acquisition unit 110, a determination unit 120, and an output unit 130.

The acquisition unit 110 acquires detection result information. The detection result information may be data themselves generated by the vibration sensor 222, or may be generated by processing the data. The detection result information includes information indicating a vibration of each of a plurality of axes detected by the vibration sensor 222, e.g., information indicating a vibration of each of three axes illustrated in FIG. 2. Further, the acquisition unit 110 stores the acquired detection result information in a storage unit 140. Therefore, the storage unit 140 can store a history of detection result information, i.e., a history of vibrations generated in the equipment 20.

The determination unit 120 processes detection result information generated at a timing at which analysis is to be performed (hereinafter, referred to as a target timing), and thereby determines presence or absence of an anomaly of the equipment 20. When the anomaly detection apparatus 10 processes data in real time, a target timing is a current time. On the other hand, when the anomaly detection apparatus 10 processes data in a batch-wise manner, a target timing is any time and date. At that time, the determination unit 120 determines presence or absence of anomaly of the equipment 20, by using pre-detection-result information at a predetermined period of time before a target timing and detection result information at the target timing.

For details, the determination unit 120 computes, with respect to each of a plurality of axes, a difference between a magnitude of a vibration at a target timing and a magnitude of a vibration at a predetermined period of time before. The determination unit 120 may compute, for example, in a predetermined period (one example of a length of the period is equal to or more than 10 seconds and equal to or less that one minute), a difference between maximum values in amplitude, or may compute a difference between average values in amplitude. At that time, the determination unit 120 determines a magnitude of a vibration at a predetermined period of time before, by using information stored in the storage unit 140. Then, the determination unit 120 determines, when a difference exceeds a criterion in any axis, that an anomaly is occurring in the equipment 20 at a target timing. A criterion used herein may be common to a plurality of axes, or may be different, in at least one axis, from another axis.

At that time, the determination unit 120 can determine a type of an anomaly, by using a type of an axis in which a difference exceeds a criterion.

The determination unit 120 determines, for example, when a difference in the x axis (first axis) illustrated in FIG. 2 exceeds a criterion, that a balance of a conveyed object 30 loaded on the belt 210 is poor. In this case, the determination unit 120 determines that a possibility in that an anomaly is occurring in an apparatus that disposes the conveyed object 30 on the belt 210 is high.

Further, the determination unit 120 determines, when a difference in the y axis (second axis) illustrated in FIG. 2 exceeds a criterion, that at least one of components constituting a belt conveyer is broken.

Further, the determination unit 120 determines, when a difference in the z axis (third axis) illustrated in FIG. 2 exceeds a criterion, that it is necessary to adjust at least one of components constituting the belt 210. In such a case, for example, a case where any component has misalignment is conceivable.

The output unit 130 executes, when the determination unit 120 detects an anomaly in the equipment 20, output indicating this matter. When the determination unit 120 also determines a type of an anomaly, the output unit 130 also outputs information indicating the type of the anomaly. The output is executed, for example, to a terminal operated by an administrator of the equipment 20.

Note that, the above-described processing may be executed in a batch-wise manner, or may be executed in real time.

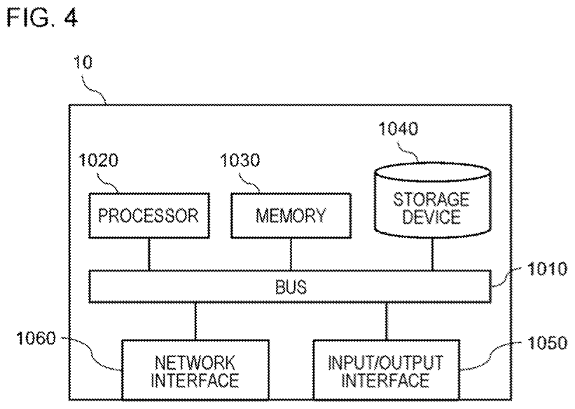

FIG. 4 is a diagram illustrating a hardware configuration example of the anomaly detection apparatus 10. The anomaly detection apparatus 10 includes a bus 1010, a processor 1020, a memory 1030, a storage device 1040, an input/output interface 1050, and a network interface 1060.

The bus 1010 is a data transmission path where the processor 1020, the memory 1030, the storage device 1040, the input/output interface 1050, and the network interface 1060 mutually transmit/receive data. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module for achieving each of functions (e.g., the acquisition unit 110, the determination unit 120, and the output 130) of the anomaly detection apparatus 10. The processor 1020 reads each of the program modules onto the memory 1030, executes the read program module, and thereby achieves each function relevant to the program module. Further, the storage device 1040 also functions as the storage unit 140.

The input/output interface 1050 is an interface for connecting the anomaly detection apparatus 10 and various types of input/output devices.

The network interface 1060 is an interface for connecting the anomaly detection apparatus 10 to a network. The network is, for example, a local area network (LAN) or a wide area network (WAN). A method for connection to a network by the network interface 1060 may be wireless connection, or may be wired connection. The anomaly detection apparatus 10 may communicate, via the network interface 1060, with the vibration sensor 222 and the control apparatus 22.

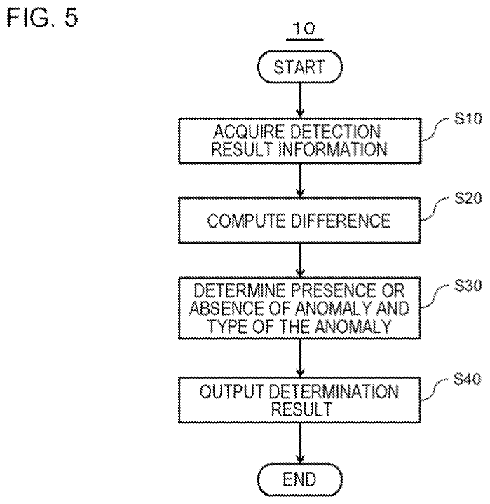

FIG. 5 is a flowchart illustrating one example of processing executed by the anomaly detection apparatus 10. The anomaly detection apparatus 10 executes processing illustrated in the present figure in real time. However, the anomaly detection apparatus 10 may execute processing equivalent to the processing illustrated in the present figure in a batch-wise manner.

First, the acquisition unit 110 acquires detection result information (step S10). Subsequently, the determination unit 120 reads, from the storage unit 140, detection result information at a predetermined period of time before, and computes a difference between the read information and the information acquired in step S10 (step S20). Then, the determination unit 120 determines, by using the computed difference, whether an anomaly is occurring in the equipment 20. Further, the determination unit 120 also determines, when an anomaly has occurred, a type of the anomaly (step S30). A specific example of processing executed in the step S30 is as described by using FIG. 3.

Thereafter, the output unit 130 outputs information indicating a determination result based on the determination unit 120 (step S40). The output may be executed only when an anomaly has been detected, or may be executed, regardless of presence or absence of an anomaly.

As described above, according to the present example embodiment, the determination unit 120 can determine, with high accuracy, whether an anomaly has occurred in the equipment 20.

Note that, according to the present example embodiment, the determination unit 120 may use, instead of a magnitude of a vibration at a predetermined period of time before, a magnitude of a vibration as a criterion, i.e., a criterion value previously set. The criterion value may be different depending on an axis direction.

While with reference to the accompanying drawings, the example embodiments according to the present invention have been described, the example embodiments are exemplification of the present invention and various configurations other than the above-described configurations are employable.

Further, in a plurality of flowcharts used in the above-described description, a plurality of steps (processing) are described in order, but an execution order of steps to be executed according to each example embodiment is not limited to the described order. According to each example embodiment, an order of illustrated steps can be modified within an extent that there is no harm in context. Further, the above-described example embodiments can be combined within an extent that there is no conflict in content.

A part or all of the example embodiment described above can be described as, but not limited to, the following supplementary notes.

1. An anomaly detection apparatus including:

an acquisition unit that acquires detection result information indicating a detection result of a vibration sensor attached to equipment including a movable unit; and

a determination unit that determines, by using the detection result information, presence or absence of an anomaly of the equipment, in which

the detection result information includes a magnitude of a vibration of each of a plurality of axes oriented in directions different from each other, and

the determination unit
computes, with respect to each of the plurality of axes, a difference between a magnitude of a vibration at a target timing, and a magnitude of a vibration at a predetermined period of time before the target timing or a criterion value previously set, and
determines, when the difference exceeds a criterion in any of the axes, that an anomaly is occurring in the equipment at the target timing.
   2. The anomaly detection apparatus according to supplementary note 1, in which

the determination unit determines a type of the anomaly by using a type of the axis in which the difference exceeds a criterion.

3. The anomaly detection apparatus according to supplementary note 2, in which

the equipment includes a belt conveyer, and

the plurality of axes are a first axis parallel to a moving direction of the belt conveyer, a second axis vertical to a surface of the belt conveyer, and a third axis parallel to a width direction of the belt conveyer.

4. The anomaly detection apparatus according to supplementary note 3, in which

the determination unit determines, when the difference in the first axis exceeds a criterion, that a balance of a conveyed object loaded on the belt conveyer is poor.

5. The anomaly detection apparatus according to supplementary note 3 or 4, in which

the determination unit determines, when the difference in the second axis exceeds a criterion, that at least one of components constituting the belt conveyer is broken.

6. The anomaly detection apparatus according to any one of supplementary notes 3 to 5, in which

the determination unit determines, when the difference in the third axis exceeds a criterion, that it is necessary to adjust at least one of components constituting the belt conveyer.

7. An anomaly detection method including:

by a computer, executing
acquisition processing of acquiring detection result information indicating a detection result of a vibration sensor attached to equipment including a movable unit; and
determination processing of determining, by using the detection result information, presence or absence of an anomaly of the equipment, in which

the detection result information includes a magnitude of a vibration of each of a plurality of axes oriented in directions different from each other, and

the computer, in the determination processing,
computes, with respect to each of the plurality of axes, a difference between a magnitude of a vibration at a target timing, and a magnitude of a vibration at a predetermined period of time before the target timing or a criterion value previously set, and
determines, when the difference exceeds a criterion in any of the axes, that an anomaly is occurring in the equipment at the target timing.
   8. The anomaly detection method according to supplementary note 7, in which

the computer determines, in the determination processing, a type of the anomaly by using a type of the axis in which the difference exceeds a criterion.

9. The anomaly detection method according to supplementary note 8, in which

the equipment includes a belt conveyer, and

the plurality of axes are a first axis parallel to a moving direction of the belt conveyer, a second axis vertical to a surface of the belt conveyer, and a third axis parallel to a width direction of the belt conveyer.

10. The anomaly detection method according to supplementary note 9, in which

the computer determines, in the determination processing, when the difference in the first axis exceeds a criterion, that a balance of a conveyed object loaded on the belt conveyer is poor.

11. The anomaly detection method according to supplementary note 9 or 10, in which

the computer determines, in the determination processing, when the difference in the second axis exceeds a criterion, that at least one of components constituting the belt conveyer is broken.

12. The anomaly detection method according to any one of supplementary notes 9 to 11, in which

the computer determines, in the determination processing, when the difference in the third axis exceeds a criterion, that it is necessary to adjust at least one of components constituting the belt conveyer.

13. A program for causing a computer to include:
an acquisition function of acquiring detection result information indicating a detection result of a vibration sensor attached to equipment including a movable unit; and
a determination function of determining, by using the detection result information, presence or absence of an anomaly of the equipment, in which

the detection result information includes a magnitude of a vibration of each of a plurality of axes oriented in directions different from each other, and

the determination function
computes, with respect to each of the plurality of axes, a difference between a magnitude of a vibration at a target timing, and a magnitude of a vibration at a predetermined period of time before the target timing or a criterion value previously set, and
determines, when the difference exceeds a criterion in any of the axes, that an anomaly is occurring in the equipment at the target timing.
   14. The program according to supplementary note 13, in which

the determination function determines a type of the anomaly by using a type of the axis in which the difference exceeds a criterion.

15. The program according to supplementary note 14, in which

the equipment includes a belt conveyer, and

the plurality of axes are a first axis parallel to a moving direction of the belt conveyer, a second axis vertical to a surface of the belt conveyer, and a third axis parallel to a width direction of the belt conveyer.

16. The program according to supplementary note 15, in which

the determination function determines, when the difference in the first axis exceeds a criterion, that a balance of a conveyed object loaded on the belt conveyer is poor.

17. The program according to supplementary note 15 or 16, in which

the determination function determines, when the difference in the second axis exceeds a criterion, that at least one of components constituting the belt conveyer is broken.

18. The program according to any one of supplementary notes 15 to 17, in which

the determination function determines, when the difference in the third axis exceeds a criterion, that it is necessary to adjust at least one of components constituting the belt conveyer.
10 Anomaly detection apparatus
20 Equipment
22 Control apparatus
30 Conveyed object
110 Acquisition unit
120 Determination unit
130 Output unit
140 Storage unit
210 Belt
220 Rotary shaft
222 Vibration sensor

It is apparent that the present invention is not limited to the above example embodiment, and may be modified and changed without departing from the scope and spirit of the invention.

What is claimed is:

1. An anomaly detection apparatus comprising:
at least one memory configured to store instructions; and
at least one processor configured to execute the instructions to perform operations comprising:
acquiring detection result information indicating a detection result of a vibration sensor attached to equipment including a movable part, the detection result information including a magnitude of a vibration of each of a plurality of axes oriented in directions different from each other;
computing, with respect to each of the plurality of axes, a difference between a magnitude of a vibration at a target timing, and a magnitude of a vibration at a predetermined period of time before the target timing or a criterion value previously set; and
determining, when the difference exceeds a criterion in any of the axes, that an anomaly is occurring in the equipment at the target timing.

2. The anomaly detection apparatus according to claim 1, wherein
the operations further comprise determining a type of the anomaly by using a type of the axis in which the difference exceeds a criterion.

3. The anomaly detection apparatus according to claim 2, wherein
the equipment includes a belt conveyer, and
the plurality of axes are a first axis parallel to a moving direction of the belt conveyer, a second axis vertical to a surface of the belt conveyer, and a third axis parallel to a width direction of the belt conveyer.

4. The anomaly detection apparatus according to claim 3, wherein
the operations further comprise determining, when the difference in the first axis exceeds a criterion, that a balance of a conveyed object loaded on the belt conveyer is poor.

5. The anomaly detection apparatus according to claim 3, wherein
the operations further comprise determining, when the difference in the second axis exceeds a criterion, that at least one of components constituting the belt conveyer is broken.

6. The anomaly detection apparatus according to claim 3, wherein
the operations further comprise determining, when the difference in the third axis exceeds a criterion, that it is necessary to adjust at least one of components constituting the belt conveyer.

7. An anomaly detection method executed by a computer, the anomaly detection method comprising:
acquiring detection result information indicating a detection result of a vibration sensor attached to equipment including a movable part, the detection result information including a magnitude of a vibration of each of a plurality of axes oriented in directions different from each other;
computing with respect to each of the plurality of axes, a difference between a magnitude of a vibration at a target timing, and a magnitude of a vibration at a predetermined period of time before the target timing or a criterion value previously set; and
determining, when the difference exceeds a criterion in any of the axes, that an anomaly is occurring in the equipment at the target timing.

8. A non-transitory computer readable medium storing a program for causing a computer to execute operations comprising:
acquiring detection result information indicating a detection result of a vibration sensor attached to equipment including a movable part, the detection result information including a magnitude of a vibration of each of a plurality of axes oriented in directions different from each other;
computing, with respect to each of the plurality of axes, a difference between a magnitude of a vibration at a target timing, and a magnitude of a vibration at a predetermined period of time before the target timing or a criterion value previously set; and
determining, when the difference exceeds a criterion in any of the axes, that an anomaly is occurring in the equipment at the target timing.
